(19) United States
(12) Patent Application Publication
(10) Pub. No.: US 2015/0020434 A1
(43) Pub. Date: Jan. 22, 2015

(54) FISH HOOK FOR THE VISUALLY IMPAIRED

(71) Applicant: Scott Kooistra, Lowell, MI (US)

(72) Inventor: Scott Kooistra, Lowell, MI (US)

(21) Appl. No.: 13/944,244

(22) Filed: Jul. 17, 2013

(51) Int. Cl. A01K 83/00

(52) U.S. Cl. CPC A01K 83/00
USPC 43/43.16

(57) ABSTRACT

A fish hook that can be easily fastened to a line or string without looking at the hook, primarily for the visually impaired.

### FIELD OF THE INVENTION

This invention relates to a fishing hook that allows the blind or visually impaired to easily place bait on.

### BACKGROUND OF THE INVENTION

The prior art fish hooks are not accommodating for the visually impaired. There is a need for a fish hook that can be easily fastened to a line for someone who is visually impaired, or blind.

Multiple embodiments of the system are disclosed herein. It will be understood that other objects and purposes of the invention, and variations thereof, will be apparent upon reading the following specification and inspecting the accompanying drawings.

### SUMMARY OF THE INVENTION

One aspect of the current invention is fish hook for the visually impaired, comprising a hook portion, a leg extending away from said hook portion, said leg extending to a loop, said loop extending to a substantially straight arm, said arm terminating at an end portion, and a distance from said end portion to said leg of about 1/32 of an inch.

These and other features, aspects and advantages of the present invention will become better understood with reference to the following drawings, description and claims.

### BRIEF DESCRIPTION OF THE DRAWINGS

FIG. 1 is a pictorial view of one embodiment of the present invention;

FIG. 2 is a pictorial view of one embodiment of the present invention; and

FIG. 3 is a pictorial view of one embodiment of the present invention.

### DETAILED DESCRIPTION

### REFERENCE NUMERALS

10 fish hook for the visually impaired

20 hook portion

30 leg

40 loop

50 arm

60 shortest distance between arm and leg

70 diameter of loop

80 end portion of the arm

90 hook-leg distance

100 length of leg

110 center of loop

120 linear axis of leg

The following detailed description is of the best currently contemplated modes of carrying out the invention. The description is not to be taken in a limiting sense, but is made merely for the purpose of illustrating the general principles of the invention, since the scope of the invention is best defined by the appended claims.

Certain terminology will be used in the following description for convenience and reference only, and will not be limiting. For example, the words “upwardly,” “downwardly,” “rightwardly,” and “leftwardly” will refer to directions in the drawings to which reference is made. The words “inwardly” and “outwardly” will refer to directions toward and away from, respectively, the geometric center of the system and designated parts. Said terminology will include the words specifically mentioned, derivatives, and similar words. Also, “connected to,” “secured to,” or similar language includes the definitions “indirectly connected to,” “directly connected to,” “indirectly secured to,” and “directly secured to.”

The directional terms, east, west, north, and south are for descriptive purposes, and any configuration may be rotated or realigned.

It should be understood, of course, that the foregoing relates to exemplary embodiments of the invention and that modifications may be made without departing from the spirit and scope of the invention as set forth in the following claims.

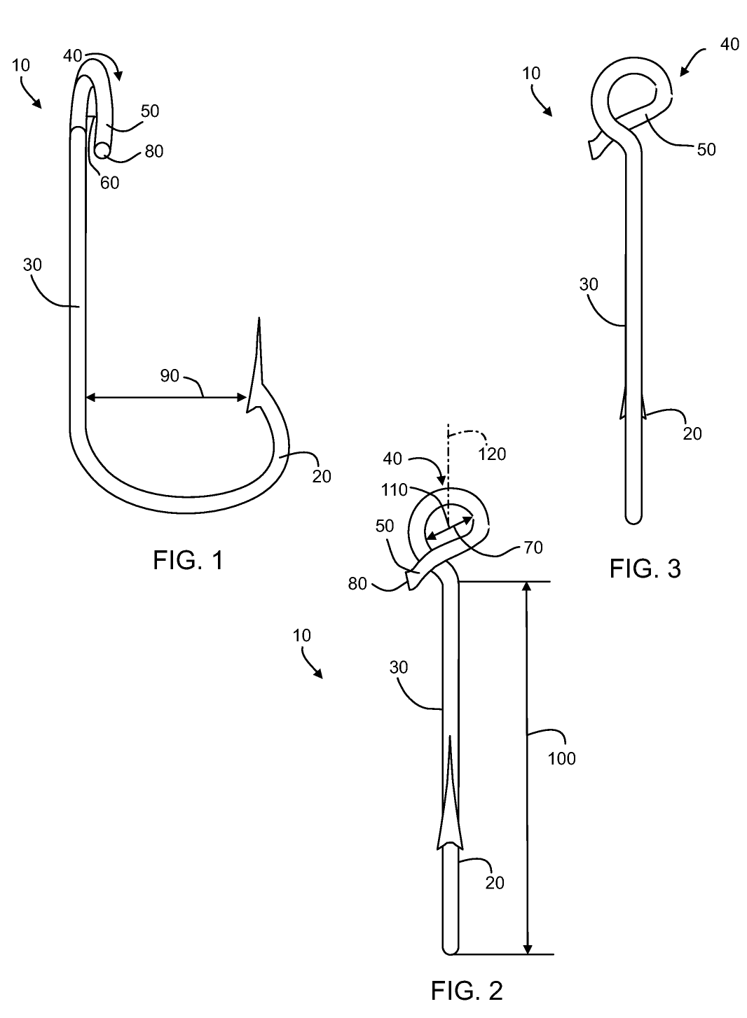

FIG. 1 illustrates one embodiment of the present invention 10, referred to as a fish hook for the visually impaired, 10. The hook 10 has a hook portion 20 that is curved, a leg portion 30 that is substantially straight and may extend from the hook 20 to a loop 40. An arm 50 may extend from the loop 40. In one embodiment the loop 40 may have a loop diameter 70 of about 1/16 of an inch. In one embodiment there may be an arm-leg distance 60 of about 1/32 of an inch, which may represent the shortest distance between the end portion of the arm 80 and the leg 30.

As seen in FIG. 1, the distance from the end of the hook 20 and the leg 30 may be about ¼ of an inch. This may be referred to as the hook-leg distance 90.

As seen in FIG. 2, the leg 30 and hook 20 may form a j-shape. The leg 30 extends away from the hook 20 to a loop 40. In one embodiment the loop may have a center 110 that may be disposed along the linear axis of the leg 120.

As seen in FIG. 3 the distance from the end portion of the arm 80 and the leg 30 may be about 1/32 of an inch, which is referred to as the arm-leg distance 60. In one embodiment the length of the leg 100 may be about 1 inch.

I claim:

1. A fish hook for the visually impaired (10), comprising:
a hook portion (20);
a leg (30) extending away from said hook portion (20);
said leg (30) extending to a loop (40)
said loop (40) extending to a substantially straight arm (50);
said arm (50) terminating at an end portion (80); and
a distance from said end portion (80) to said leg (30) of about 1/32 of an inch.

2. The apparatus of claim 1, wherein:
said loop (40) has a diameter of about 1/16 of an inch.

3. The apparatus of claim 1, wherein:
said loop (40) has a center (110) that is disposed along the linear axis of the leg (120).
